(19) United States
(12) Patent Application Publication
(10) Pub. No.: US 2026/0112175 A1
(43) Pub. Date: Apr. 23, 2026

(54) METHOD FOR PROCESSING AT LEAST ONE IMAGE GENERATED BY AT LEAST ONE CAMERA MOUNTED ON A VEHICLE, IN PARTICULAR ON A MOTOR VEHICLE

(71) Applicant: Robert Bosch GmbH, Stuttgart (DE)

(72) Inventors: Eashwara Sudharsan Erahan, Hildesheim (DE); Fabian Gigengack, Hemmingen (DE); Simon Roesler, Hildesheim (DE); Moritz Michael Knorr, Hildesheim (DE)

(21) Appl. No.: 19/347,854

(22) Filed: Oct. 2, 2025

(30) Foreign Application Priority Data
Oct. 21, 2024 (DE) 10 2024 210 136.2

(51) Int. Cl. G06V 20/56; G06T 7/70; G06T 7/80; H04N 23/695

(52) U.S. Cl. CPC G06V 20/56; G06T 7/70; G06T 7/80; H04N 23/695; G06T 2207/20084

(57) ABSTRACT

A method for processing at least one image generated by at least one camera mounted on a vehicle, in particular on a motor vehicle or rail vehicle or a mobile robot having a drive. The method includes: a) determining a relative orientation of a camera coordinate system defining the alignment of the at least one camera relative to a vehicle coordinate system; b) transforming at least one image generated by the camera into a normalized image according to the ascertained relative orientation; and c) carrying out at least one image processing measure in the at least one transformed image and/or at least one image analysis measure based on the at least one transformed image, wherein measures a) and b) are carried out prior to measure c).

### CROSS REFERENCE

The present application claims the benefit under 35 U.S.C. § 119 of Germany Patent Application No. DE 10 2024 210 136.2 filed on Oct. 21, 2024, which is expressly incorporated herein by reference in its entirety.

### FIELD

The present invention relates to a method for processing at least one image generated by at least one camera mounted on a vehicle, in particular on a motor vehicle.

The present invention also relates to a deep learning system that is configured/programmed for carrying out the method of the present invention.

The present invention also relates to a vehicle having a control unit that is configured/programmed for carrying out the method of the present invention.

Furthermore, the present invention relates to a computer program product designed to carry out the method of the present invention, in particular by means of the deep learning system.

Furthermore, the present invention comprises a computer-readable data carrier for carrying out the method of the present invention.

### BACKGROUND INFORMATION

In camera-based image processing of images recorded by a camera present in a vehicle, various corrections are often made to the recorded raw image in order to correct imaging errors, for example those caused by distortions in the camera lens. Pixel-by-pixel intensity correction, such as gamma correction, is also often performed.

The recorded 2A image can also be converted into a 3D image.

Said images can be further processed by means of image processing methods and, alternatively or additionally, subjected to image analysis and then made available to the vehicle for further use.

If two or more cameras are installed in the vehicle, the relative orientations of the individual cameras relative to a reference coordinate system defined by the vehicle—hereinafter referred to as the “vehicle coordinate system”—can differ significantly from one another.

The same applies to a fleet of a plurality of vehicles, in which in each case at least one camera is provided. In particular, there may be significant deviations in the transformation from the two-dimensional image space to the reference coordinate system for the individual cameras, since the individual cameras provided in the vehicle can be aligned in different directions.

This can pose significant challenges for a deep learning system or a neural network, in particular when transforming the image from 2D to 3D.

It is an object of the present invention to provide an improved method for processing at least one image generated by at least one camera present in a vehicle, in which the above-mentioned problem is at least partially eliminated.

This object may be achieved by certain features of the present invention. Preferred embodiments of the present invention are disclosed herein.

### SUMMARY

A basic idea of the present invention is to normalize the orientation of the camera relative to the vehicle prior to the actual image processing or image analysis of the images generated by a camera installed on the vehicle, in particular a motor vehicle or rail vehicle or movable robot.

This is to be understood as meaning that a camera coordinate system defining the orientation of the camera relative to the motor vehicle is transformed, in particular by rotation about a suitable rotational axis, so that a coordinate system axis of the camera coordinate system, which prior to the rotation is arranged at an angle to the corresponding coordinate system axis of a vehicle coordinate system defining the orientation of the vehicle, runs parallel to this coordinate system axis of the motor vehicle after such a rotation about the rotational axis.

With the aid of such camera normalization, the images recorded by the camera can be converted into transformed images, so that these, like the camera, are normalized with respect to their alignment to the vehicle coordinate system.

In particular, according to an example embodiment of the present invention, it can be provided that a Z-axis of the camera coordinate system is aligned parallel to a Z-axis of the vehicle coordinate system, so that the field of view of the camera runs horizontally after this transformation.

By means of the alignment or normalization described above, further processing of the images generated by the camera by means of image analysis or image processing is substantially facilitated. This is true in particular if further processing is carried out with the aid of a deep learning system or a neural network.

Following the above inventive concept, the method according to an example embodiment of the present invention for processing at least one image that was generated by at least one camera present in a vehicle comprises three measures a) to c).

According to a first measure a), a relative orientation of a camera coordinate system defining the alignment of the at least one camera relative to a vehicle coordinate system of the vehicle is determined.

In a second measure b), at least one image generated by the camera is transformed into a normalized image according to the ascertained relative orientation.

In a third measure c), at least one image processing measure is carried out in the at least one normalized image. Alternatively or additionally, in the third measure c), at least one image analysis measure is carried out based on the at least one normalized image. Such an image processing measure can be or comprise a further transformation of the image transformed by means of the normalized camera, i.e., the conversion of the image into another image, in particular by means of a virtual camera. In particular, it may comprise a bird's eye view transformation.

As an image analysis measure, object recognition, preferably 3D object recognition, in the transformed or further transformed image is taken into particular consideration.

According to an example embodiment of the present invention, measures a) and b) are in each case carried out prior to measure c). Thus, a normalized image is available before actual image processing and image analysis measures are carried out.

In a preferred embodiment of the method according to the present invention, an extrinsic calibration matrix, by means of which the orientation of the camera in the vehicle coordinate system is defined, is converted into a normalized extrinsic calibration matrix according to the relative orientation ascertained in measure a). In this embodiment, at least the image generated by the camera is converted into the normalized image taking into account the normalized extrinsic calibration matrix and thus taking into account the ascertained relative orientation of the camera coordinate system relative to the vehicle coordinate system of the normalized extrinsic calibration matrix. The further processing of such a normalized image by a deep learning system or neural network is considerably simpler and less error-prone than the further processing of a non-normalized image by the deep learning system or neural network.

According to an advantageous further development of the present invention, for determining the normalized extrinsic calibration matrix, the camera coordinate system is rotated about a specific rotational axis and in this way converted into a rotated camera coordinate system, so that after this rotation a Z-direction of the camera coordinate system extends parallel to a Z-direction of the vehicle coordinate system.

If two or more cameras are installed in the vehicle, they can all be aligned with their Z-direction parallel to the Z-direction of the vehicle coordinate system with respect to the camera coordinate system by means of the procedure described above. This simplifies the further processing of the images generated by the various cameras by a deep learning system or neural network. The same applies to in each case at least one camera mounted in the individual vehicles of a vehicle fleet consisting of a plurality of vehicles, and—possibly due to tolerances—aligned differently with respect to the particular vehicle coordinate system.

According to a further advantageous further development of the method according to the present invention, at least two cameras having different extrinsic calibration matrices can be provided on the vehicle. In this further development, in each case an individual normalized extrinsic calibration matrix can then be determined for the at least two cameras. In this way, the images generated by all cameras can be normalized as described above.

Particularly preferably, for determining the particular normalized extrinsic calibration matrix, a first basis vector of each camera coordinate system can be rotated about a specific rotational axis and in this way converted into a rotated camera coordinate system, such that, after this rotation, it extends parallel to the first basis vector of the vehicle coordinate system, such that, after the rotation, the first basis vectors of all camera coordinate systems extend parallel to the first basis vector of the vehicle coordinate system and also parallel to one another.

Particularly preferably, according to an example embodiment of the present invention, the first basis vector extends along a particular Z-axis of the camera coordinate system or the vehicle coordinate system.

In a preferred embodiment of the present invention, for the transformation of the image into the normalized image, a plurality of lines of sight extending from the camera defined by the rotated camera coordinate system to the image are defined. By projecting the lines of sight of this rotated camera into the original image, image coordinates are determined, based on which the transformed image can be calculated from the original image by means of interpolation.

Particularly preferably, according to an example embodiment of the present invention, measures a to c) can be carried out by at least one deep learning system having at least one, preferably self-learning, neural network.

The present invention further relates to a deep learning system that comprises at least one neural network, which in turn is configured/programmed to carry out the method according to the present invention presented above. Therefore, the advantages of the method according to the present invention explained above are transferred to the deep learning system according to the present invention.

Furthermore, the present invention relates to a computer program product designed to carry out the method of the present invention, in particular by means of the deep learning system. The computer program product contains instructions that, when the computer program product is executed by the control device of the vehicle and/or by the deep learning system thereof, cause the method of the present invention to be carried out. Therefore, the advantages of the method according to the present invention explained above are transferred to the computer program product according to the present invention.

The computer program product is preferably stored on a memory comprising at least one non-volatile memory.

Likewise, the present invention comprises a computer-readable data carrier for carrying out the method of the present invention. The data carrier comprises instructions that, when executed, cause the control unit of the vehicle and/or the deep learning system to carry out the method according to the present invention explained above. The advantages of the method according to the present invention described above are therefore transferred to the data carrier according to the present invention.

Further important features and advantages of the present invention can be found in the disclosure herein.

It is self-evident that the features mentioned above and those still to be explained below can be used not only in the combination specified in each case but also in other combinations or alone, without departing from the scope of the present invention.

Preferred exemplary embodiments of the present invention are illustrated in the figures and are explained in more detail in the following description, wherein the same reference signs refer to identical or similar or functionally identical components.

### BRIEF DESCRIPTION OF THE DRAWINGS

FIG. 1 shows a motor vehicle having a camera recording an image of the front region of the motor vehicle, according to an example embodiment of the present invention.

FIG. 2 shows a flowchart illustrating the method according to an example embodiment of the present invention.

FIG. 3 shows a representation illustrating the rotation of the camera system.

FIG. 4 shows a representation illustrating the normalized camera.

FIG. 5 shows an image of the front region of the motor vehicle recorded by the camera prior to the normalization substantial to the present invention.

FIG. 6 shows the image of FIG. 5 transformed after normalization of the camera.

### DETAILED DESCRIPTION OF EXAMPLE EMBODIMENTS

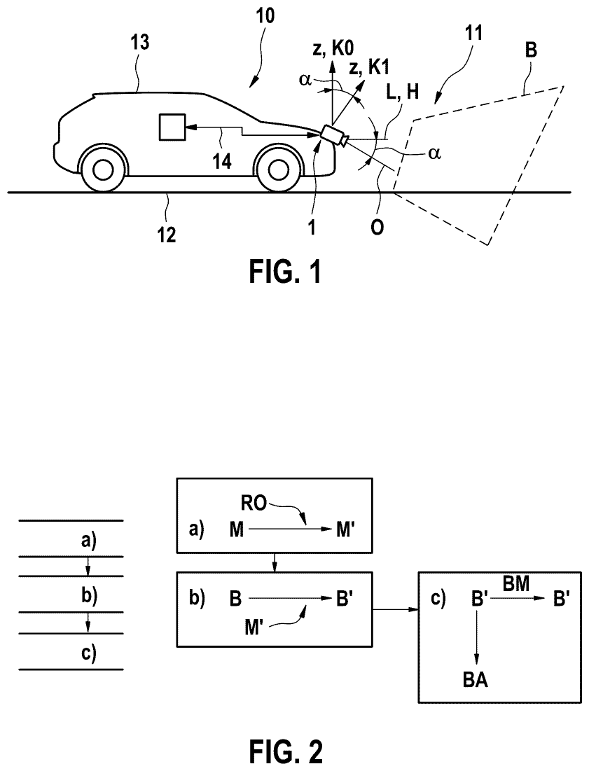

FIG. 1 shows an example of a vehicle according to the invention in the form of a motor vehicle 10 traveling on a roadway 12 in a schematic representation and in a kind of side view. In variants not shown, the vehicle can also be a rail vehicle or a self-propelled robot or another movable object that is suitable for traveling on the roadway 12.

The motor vehicle 10 comprises a camera 1 that monitors a front region 11 of the motor vehicle 10 and for this purpose generates an image B of this front region 11. All generated images B are transmitted via a communication connection 14 to a control unit 13 of the motor vehicle 10, which carries out the method according to the invention during operation.

This method is explained below by way of example. For this purpose, reference is made to the flowchart shown in FIG. 2.

Accordingly, the method according to the invention comprises three measures a) to c).

As can be seen from a summary of FIGS. 1 to 3, in a first measure a) a relative orientation RO of a camera coordinate system K1 defining the alignment of the at least one camera 1 relative to a vehicle coordinate system K0 of the motor vehicle 10 is determined.

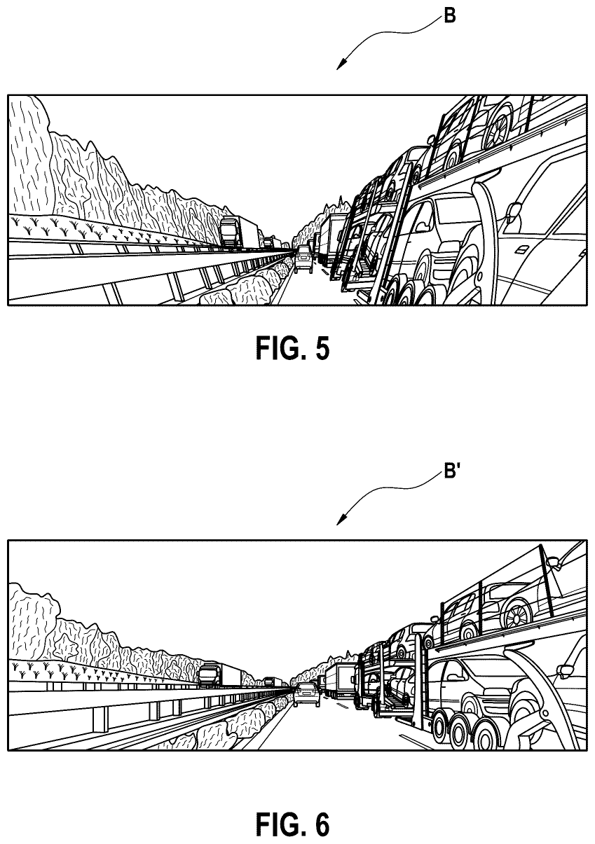

In the example of the figures, the Z-axis of the coordinate system K0 is rotated by an angle α with respect to the Z-axis of camera 1. This angle α is the angle by which an optical axis O of the camera 1 is rotated downwards, i.e., towards the roadway 12, relative to a horizontally extending longitudinal axis L of the motor vehicle 10 (see FIG. 1). The image B of the front region 11 shown in FIG. 5 and recorded by camera 1 was thus recorded by the camera 1 which is tilted downwards relative to the horizontal H.

In the course of measure a), according to the ascertained relative orientation, a specified extrinsic calibration matrix M, by means of which the orientation of the camera 1 in the vehicle coordinate system K0 is defined, is converted into a normalized extrinsic calibration matrix M′.

The extrinsic calibration matrix M is defined as

$$\underline{M} = [ \begin{matrix}\underline{R} & \vec{t} \\ {\vec{0}}^{T} & 1\end{matrix} ]$$

R is a 3×3 rotation matrix and t is a 3×1 translation vector. The rotation matrix R is defined according to the so-called image coordinate convention, which means that the X-axis extends to the right, the Y-axis extends downwards and the Z-axis extends forwards.

In the following, the ascertainment of the above-described relative orientation RO of the camera coordinate system K1 relative to the vehicle coordinate system K0 is explained in order to normalize the camera 1 horizontally.

For this purpose, the vector component along the Z-direction must be extracted in the so-called DIN-70K coordinate convention of the camera 1, in which, contrary to the image coordinate convention, the X-axis points forward, the Y-axis points left and the Z-axis points upward.

If the rotation matrix R is defined

$$\underline{R} = [ \begin{matrix}{\vec{R}}_{0} & {\vec{R}}_{1} & {\vec{R}}_{2}\end{matrix} ] as$$

$${\vec{R}}_{i} ∈ , i ∈ \{ 0 , 1 , 2 \} ,$$

then the relative orientation RO of the vector \vec{u}_{DIN70k} with respect to the target vector pointing in the z-direction \vec{u}_{Target}, which points in the Z-direction, results in

$${\vec{u}}_{DIN 70 k} = - \vec{R} 1 .$$

In order to align the vector \vec{u}_{DIN70k} parallel to the vector \vec{u}_{Target}, it is necessary to rotate the latter vector about a rotation axis D, which extends along a direction defined by the direction vector \vec{n},

wherein

$$\vec{n} = {\vec{u}}_{DIN 70 k} x {\vec{u}}_{Target}$$

The required rotational angle α to align the rotational angle \vec{u}_{DIN70k} parallel to the vector \vec{u}_{Target} is calculated as

$$α = {cos}^{- 1} 〈 {\vec{u}}_{DIN 70 k} , {\vec{u}}_{DIN 70 k}^{target} 〉$$

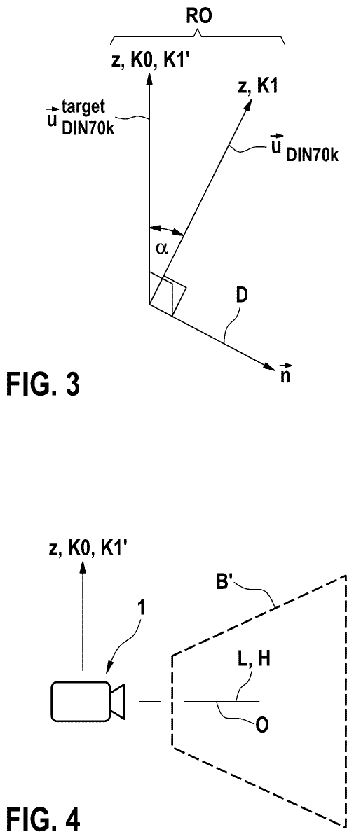

Said rotation is illustrated in FIG. 3.

For determining the normalized extrinsic calibration matrix M′, the camera coordinate system K1 is rotated about a rotational axis D defined by the direction vector \vec{n}, as shown in FIG. 3, and in this way converted into a rotated camera coordinate system K1′ of which the Z-direction Z1 extends parallel to the Z-direction of the vehicle coordinate system K0.

Using the vector \vec{n} and the rotational angle α, the Rodrigues' formula known to a person skilled in the art can be used to calculate a correction rotation matrix R_{Correction}, which reflects the rotation of the camera coordinate system K. Due to the matrix multiplication of the correction rotation matrix R_{Correction} with the original rotation matrix R, a modified rotation matrix R_{mod} results, which causes the above-described alignment or rotation of the camera coordinate system K1′ with Z-direction Z1′ parallel to the Z-direction Z0 of the vehicle coordinate system K0. From the modified rotation matrix R_{mod}, the desired modified calibration matrix M′ can in turn be calculated as follows:

$$\underline{M '} = [ \begin{matrix}{R}_{mod} & \vec{t} \\ {0}^{T} & 0\end{matrix} ]$$

Following measure a), in a second measure b) the image B generated by the camera 1 (see FIG. 4) is converted into the normalized image B′ (see FIG. 6) with the aid of the ascertained extrinsic calibration matrix M′ and thus taking into account the ascertained relative orientation of the camera coordinate system K1. The camera 1 rotated in this way with the image B′ transformed by the rotation and thereby normalized is shown in FIG. 4 in a representation corresponding to FIG. 1.

Now referring again to FIG. 2, in a third measure c) an image processing step BM is carried out in the normalized image B′ and in this way the normalized image B′ is converted into a processed normalized image B″. Alternatively or additionally, in the third measure c), at least one image analysis measure BA can be based on the at least one normalized image B′. In both alternatives, measures a) and b) are in each case carried out prior to measure c), and measure a) is in turn carried out prior to measure b).

As an image processing measure (BM), a further transformation of the image, i.e., the conversion of the image into another image, particularly by means of a virtual camera, is taken into consideration. In particular, a transformation into a bird's-eye view is conceivable. As an image analysis measure BA, object recognition, in particular 3D object recognition, in the transformed or further transformed image is taken into consideration.

What is claimed is:

1. A method for processing at least one image generated by at least one camera mounted on a vehicle, the vehicle being a motor vehicle or rail vehicle or a mobile robot having a drive, the method comprising the following steps:
a) determining a relative orientation of a camera coordinate system defining an alignment of the at least one camera relative to a vehicle coordinate system;
b) transforming at least one image generated by the camera into a normalized image according to the ascertained relative orientation; and
c) carrying out at least one image processing measure on the at least one normalized image and/or at least one image analysis measure based on the at least one normalized image;
wherein steps a) and b) are carried out prior to step c).

2. The method according to claim 1, wherein:
according to the ascertained relative orientation, an extrinsic calibration matrix, using which the orientation of the camera in the vehicle coordinate system is defined, is converted into a normalized extrinsic calibration matrix,
the image generated by the camera is converted into the normalized image taking into account the normalized extrinsic calibration matrix.

3. The method according to claim 2, wherein:
for determining the normalized extrinsic calibration matrix, the camera coordinate system is rotated about a specific rotational axis and in this way converted into a rotated camera coordinate system, so that after the rotation, a Z-direction of the rotated camera coordinate system extends parallel to a Z-direction of the vehicle coordinate system.

4. The method according to claim 3, wherein:
at least two different cameras having different extrinsic calibration matrices are provided on the motor vehicle,
in each case, a respective individual normalized extrinsic calibration matrix is determined for the at least two cameras.

5. The method according to claim 1, wherein:
for each of the cameras, for determining the respective normalized extrinsic calibration matrix, a first basis vector of each camera coordinate system is rotated about a specific rotational axis and in this way converted into a rotated camera coordinate system, such that, after the rotation, the first basis vector extends parallel to the first basis vector of the vehicle coordinate system, such that, after the rotation, the first basis vectors of the camera coordinate systems extend parallel to the first basis vector of the vehicle coordinate system and also parallel to one another.

6. The method according to claim 3, wherein:
for the transformation of the image into the normalized image, lines of sight are be defined from the camera defined by the rotated camera coordinate system to the image, and
by projecting the lines of sight of the rotated camera into the original image, image coordinates are determined, from which the transformed image is calculated from the original image using interpolation.

7. The method according to claim 6, wherein steps a) and b) are carried out by at least one self-learning neural network.

8. A deep learning system, comprising:
at least one neural network configured/programmed to carry out a method for processing at least one image generated by at least one camera mounted on a vehicle, the vehicle being a motor vehicle or rail vehicle or a mobile robot having a drive, the method including the following steps:
a) determining a relative orientation of a camera coordinate system defining an alignment of the at least one camera relative to a vehicle coordinate system;
b) transforming at least one image generated by the camera into a normalized image according to the ascertained relative orientation; and
c) carrying out at least one image processing measure on the at least one normalized image and/or at least one image analysis measure based on the at least one normalized image;
wherein steps a) and b) are carried out prior to step c).

9. A motor vehicle or rail vehicle or mobile robot, comprising:
at least one camera for monitoring a surrounding area of the motor vehicle or rail vehicle or mobile robot; and
a control device that interacts with the camera and is configured to process at least one image generated by the at least one camera, the control device configured to perform the following steps:
a) determining a relative orientation of a camera coordinate system defining an alignment of the at least one camera relative to a vehicle coordinate system;
b) transforming at least one image generated by the camera into a normalized image according to the ascertained relative orientation; and
c) carrying out at least one image processing measure on the at least one normalized image and/or at least one image analysis measure based on the at least one normalized image;
wherein steps a) and b) are carried out prior to step c).

10. A non-transitory data carrier on which are stored instructions for processing at least one image generated by at least one camera mounted on a vehicle, the vehicle being a motor vehicle or rail vehicle or a mobile robot having a drive, the instructions, when executed by the vehicle or by a deep learning system, causing the vehicle or the deep learning system to perform the following steps comprising:
a) determining a relative orientation of a camera coordinate system defining an alignment of the at least one camera relative to a vehicle coordinate system;
b) transforming at least one image generated by the camera into a normalized image according to the ascertained relative orientation; and
c) carrying out at least one image processing measure on the at least one normalized image and/or at least one image analysis measure based on the at least one normalized image;
wherein steps a) and b) are carried out prior to step c).
